(19) United States
(12) Patent Application Publication
(10) Pub. No.: US 2005/0186053 A1
(43) Pub. Date: Aug. 25, 2005

(54) Automatic storage and retrieval system

(75) Inventor: Kazuo Itoh, Kasai-shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: ITOH DENKI CO., LTD., Kasai-shi (JP)

(21) Appl. No.: 11/075,834

(22) Filed: Mar. 10, 2005

(30) Foreign Application Priority Data
Aug. 22, 2002 (JP) 2002-241286

(51) Int. Cl. B65G 1/00

(52) U.S. Cl. 414/285

(57) ABSTRACT

An automatic storage and retrieval system comprises at least one entrance opening, at least one delivery opening, a goods storage section having at least one storage layer in which unit goods storage sections are disposed in row and column, a goods conveyance section for selecting a stored good (rack) freely in direction and for accepting and sending out the stored good, the goods conveyance section being provided at each of the unit goods storage sections, and a conveyance control section for guiding the stored good to the delivery opening by the delivering date and time of the stored good upon reception of the stored good through the entrance opening.

### BACKGROUND OF THE INVENTION

1. Field of the Invention

The present invention relates to an automatic storage and retrieval system for sequentially entering stored goods through an entrance opening, and for delivering the stored goods through a delivery opening at a delivery date and time predetermined for each stored good, and to a method for conveying stored goods within a three-dimensional warehouse.

2. Background Information

From the past, a stacker crane, rotating location (horizontal, vertical), or the like, for example, is employed when goods are stored/managed three-dimensionally within a warehouse. Manpower, forklift or the like is employed for piling up/down of such goods when goods are to be entered into/delivered from the warehouse.

When manpower is employed, however, disadvantages arise such that a good to be delivered from may be took mistaken, a good is fallen so as to make the good to be an inferior good, and the work becomes insufficient. When forklift is employed, disadvantages arise such that the forklift cannot reach to a location which is too high, an operator is required for operating the forklift, the operator is required to be practiced to some degree, and space for moving the forklift should be secured.

When goods stored in the stacker crane or rotating shelf are delivered from, a disadvantage arises in that the stacker crane or rotating shelf is driven after the goods to be delivered are specified, therefore time is consumed for conveying the goods to the delivery location. Particularly, a disadvantage arises in that even when a plurality of goods is taken out at a time, goods are delivered one by one sequentially so that an extremely long time is required for the delivery.

The present invention was made in view of the above problems.

### SUMMARY OF THE INVENTION

It is an object of the present invention to provide an automatic storage and retrieval system and a method for conveying stored goods within a three-dimensional warehouse, both can utilize the storage space within the warehouse at the maximum, can carry out the conveyance from the entrance of the goods to the keeping of the goods, the delivery of the goods in an unmanned condition, and can securely deliver the goods at the expected date and time especially.

To realize the above object, an automatic storage and retrieval system of a first aspect according to the present invention is characterized in comprising: at least one entrance opening for entering goods into the three-dimensional warehouse, at least one delivery opening for delivering goods from the three-dimensional warehouse, goods storage section having at least one layer of storage layer on which unit goods storage sections are disposed in matrix; goods conveyance means provided in each of the unit goods storage sections, the goods conveyance means being able to receive/deliver stored goods by selecting the stored goods in a flexible direction, and conveyance control means for guiding the stored good to the delivery opening by delivery date and time of the stored good, upon entrance of the stored good through the entrance opening.

In the automatic storage and retrieval system, after goods are sequentially entered through the entrance opening, the goods are moved through the unit goods storage section by the goods conveyance means of the unit goods storage section, and are guided to the delivery opening by the delivery date and time. That is, goods are conveyed through an appropriate path from the entrance opening to the delivery opening, the path being selected corresponding to entangled degree of the stored goods within the unit goods storage section. Therefore, the apparatus can utilize the storage space within the warehouse at the maximum, can carry out the conveyance from the entrance of the goods to the keeping of the goods, delivery of the goods in an unmanned condition.

In this automatic storage and retrieval system, the goods conveyance means is not limited as well as the means being able to receive/deliver the goods by selecting the stored goods in a flexible direction. For example, one of second to fifth aspect (described later) according to the present invention is preferably employed.

In an automatic storage and retrieval system of second aspect according to the present invention, the goods conveyance means comprises a conveyance direction change section for changing the conveyance direction to any one direction among forward, reverse, left and right directions, and a goods conveyance section for conveying the stored good in the direction changed by the conveyance direction change section. The concrete arrangement of the goods conveyance means is disclosed in co-pending Japanese Patent Laid-Open Publication No. 2002-2932, entitled “Conveyance Direction Changing Apparatus” (the same applicant as the present application) whose disclosure is incorporated herein by reference.

In an automatic storage and retrieval system of third aspect according to the present invention, the goods conveyance means comprises a conveyer line for conveying the stored good in one direction, and a cross-feeder disposed within the conveyer line, the cross-feeder delivering the stored good into another conveyer line for conveying in a direction perpendicular to the conveyance direction of the conveyer line from which the stored good is delivered. The concrete arrangement of the goods conveyance means is disclosed in Japanese Patent No. 3241487 (patent owner is the same as the applicant of the present application) entitled “Cross-Feeder”, and in co-pending Japanese Patent Laid-Open Publication No. 2000-168948 (applicant is the same as that of the present application) entitled “Cross-Feeder”, whose disclosure are incorporated herein by reference.

In an automatic storage and retrieval system of fourth aspect according to the present invention, the goods conveyance means have an inclined conveyer for conveying the stored good from the upper storage layer to the lower storage layer in a case that the goods storage section has multiple storage layers, and wherein the inclined conveyer has an entrance/delivery section for entering into/delivering from with respect to each storage layer which is one storage layer from the uppermost storage layer to the lowermost storage layer. In an automatic storage and retrieval system of fifth aspect according to the present invention, the goods conveyance means have an elevator for conveying the stored good from an upper storage layer to a lower storage layer, and vice versa in a case that the goods storage section has multiple storage layers.

Further, in an automatic storage and retrieval system according to the present invention, the conveyance control means carry out the following control (1) (sixth, seventh, and eighth aspects), (2) (ninth, tenth, and eleventh aspects), and (3) (twelfth, thirteenth, and fourteenth aspects).

(1) The conveyance control means convey the stored good to a neighboring unit goods storage section in a case that the neighboring unit goods storage section in the conveyance direction of the stored good has no stored goods.

(2) The conveyance control means search for a detour in a case that the neighboring unit goods storage section in the conveyance direction of the stored good has stored goods, and convey the stored good in the detour direction in a case that the detour exists.

(3) The conveyance control means search for a detour in a case that the neighboring unit goods storage section in the conveyance direction of the stored good has stored goods, and wherein the conveyance control means compare the delivery date and time of the stored good for conveyance and the delivery date and time of the stored good in the neighboring unit goods storage section, and wherein the conveyance control means make the stored good in the neighboring unit goods storage section to take shelter in a case that the delivery date and time of the stored good for conveyance is earlier.

Further, in an automatic storage and retrieval system according to the present invention, the conveyance control means may be provided at the goods conveyance means of each unit goods storage section (15th to 20th aspects), or may be provided at each stored good (21st to 26th aspects). A system server may be provided for carrying out supervising control of the conveyance control means (27th to 34th aspects).

A method for conveying stored goods within a three-dimensional warehouse of 35th aspect according to the present invention is characterized in that the three-dimensional warehouse comprises at least one entrance opening for entering goods into the three-dimensional warehouse, at least one delivery opening for delivering goods from the three-dimensional warehouse, and a goods storage section having at least one layer of storage layer on which unit goods storage sections are disposed in matrix, and that the method comprises the steps of sequentially entering stored goods through an entrance opening of the three-dimensional warehouse which has goods conveyance means for entering into/delivering from with respect to each of the unit goods storage section by selecting the stored goods in a flexible direction, conveying the stored goods through the unit goods storage section by the goods conveyance means of each unit goods storage section, and guiding the stored good to the delivery opening by the delivery date and time of the stored good.

Also, the method can utilize the storage space within the warehouse at the maximum, and can carry out the conveyance from the entrance of the goods to the keeping of the goods, delivery of the goods in an unmanned condition.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic diagram illustrating a goods storage section (storage space) within a three-dimensional warehouse in an automatic storage and retrieval system of an embodiment according to the present invention, the goods storage section being partitioned into 48 (=4 in vertical×4 in horizontal×3 in height) unit goods storage sections;

FIG. 2 is a schematic diagram useful in understanding conveyance control of stored goods within a three-dimensional warehouse in an automatic storage and retrieval system of an embodiment according to the present invention;

FIG. 3 is a schematic plan view of goods conveyance means of a form used in a three-dimensional warehouse of an embodiment according to the present invention;

FIG. 4 is a schematic plan view of goods conveyance means of another form used in a three-dimensional warehouse of an embodiment according to the present invention;

FIG. 5 is a perspective view of goods conveyance means of a further form used in a three-dimensional warehouse of an embodiment according to the present invention;

FIG. 6 is a perspective view illustrating interior of a three-dimensional warehouse in which plural storage layers are provided and an inclined conveyer is provided for conveying stored goods from an upper storage layer to a lower storage layer;

FIG. 7 is a perspective view illustrating entering section/delivering section for entering into/delivering from each storage layer between the uppermost storage layer and the lowermost layer, in the inclined conveyer illustrated in FIG. 6;

FIG. 8 is a block diagram illustrating an arrangement of control system of a three-dimensional warehouse of an embodiment according to the present invention;

FIG. 9 is a block diagram illustrating an arrangement of a stage terminal device illustrated in the block diagram of FIG. 8;

FIG. 10 is a diagram representing data which is stored in a card attached to a stored good;

FIG. 11 is a diagram representing data which is stored in a data storage section illustrated in FIG. 9;

FIG. 12 is a flow diagram useful in understanding processing operation of the stage terminal device illustrated in the block diagram of FIG. 8;

FIG. 13 is a flow diagram useful in understanding a reception interruption processing in a case that data transmission request and the like are provided for the stage terminal device from rear terminal device, in the stage terminal device illustrated in the block diagram of FIG. 8; and

FIG. 14 is a flow diagram useful in understanding processing operation of a rack terminal device in a case that a terminal device is provided at a moving rack.

### DETAILED DESCRIPTION OF THE PREFERRED EMBODIMENTS

Hereinafter, referring to the embodiments, the present invention is described in more detail.

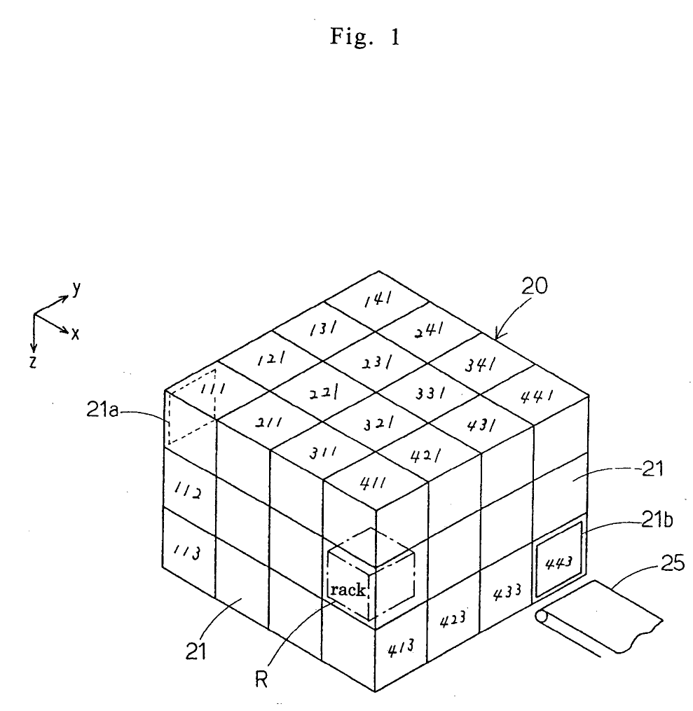

FIG. 1 illustrates a schematic diagram illustrating a goods storage section (storage space) 20 within a three-dimensional warehouse in an automatic storage and retrieval system of an embodiment according to the present invention, the goods storage section 20 being partitioned into 48 (=4 in vertical×4 in horizontal×3 in height) unit goods storage sections 21. In FIG. 1, 16 unit goods storage sections 21 consist one storage layer, and 3 storage layers are provided. Among the unit goods storage sections 21, an entrance opening 21a is established at a unit goods storage section 21 designated as No. 111 in the uppermost storage layer, and a delivery opening (sending out opening) 21b at a unit goods storage section 21 designated as No. 443 in the lowermost storage layer.

Multiple entrance openings 21a and multiple delivery openings 21b may be provided. The entrance opening 21a and delivery opening 21b may be established at any storage layer. That is, although the entrance opening is established at the uppermost storage layer, and the delivery opening is established at the lowermost storage layer, in the above example, the entrance opening may be established at the lowermost storage layer, and the delivery opening may be established at the uppermost storage layer, or the entrance opening may be established at the uppermost storage layer, and the delivery opening may be established at an intermediate storage layer. Further, usage may be applicable that the uppermost storage layer is for entrance only, the intermediate storage layer is for waiting delivery, and the lowermost storage layer is for waiting next delivery.

Although it is not illustrated in FIG. 1, a goods conveyance means (described later in detail) which can enter/deliver a stored good (rack) R by selecting the stored good in flexible direction, is provided at each unit goods storage section 21. The conveyance control means guides a stored good R to the delivery opening 21b by the delivery date and time (sending out date and time) of the stored good R when the stored good R is entered through the entrance opening 21a. This conveyance control means is provided at the goods conveyance means of each unit goods storage section 21 or at each stored good R, as is described earlier.

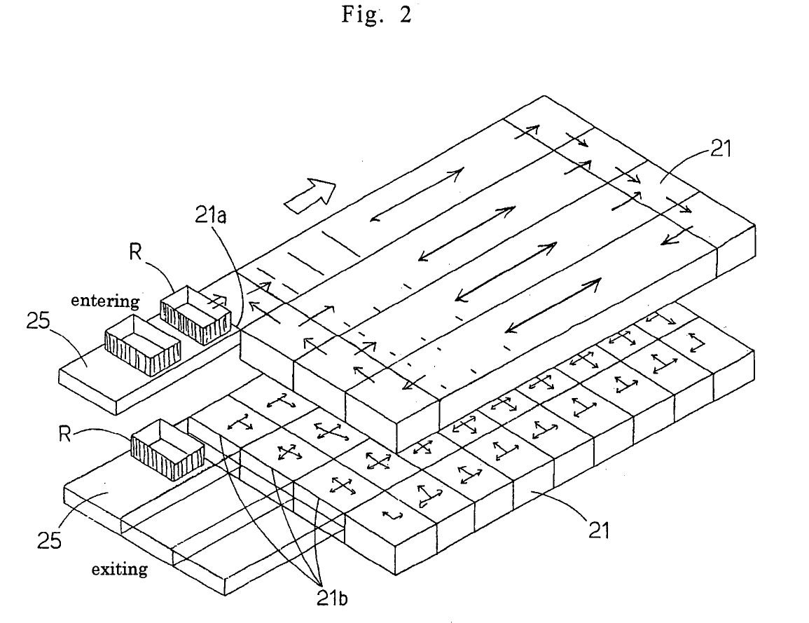

In the example of FIG. 1, the stored good R entered through the entrance opening 21a is conveyed through the unit goods storage section 21 by the goods conveyance means of each unit goods storage section 21, is conveyed downward from the uppermost storage layer to the intermediate storage layer, and from the intermediate storage layer to the lowermost storage layer, is reached the delivery opening 21b prior to the delivery date and time, and is delivered from the three-dimensional warehouse by the belt conveyer 25 at the delivery date and time. The stored goods R may directly be conveyed from the uppermost storage layer to the lowermost storage layer. FIG. 2 is a schematic diagram useful in understanding the conveyance control of the stored good R. In FIG. 2, one entrance opening 21a is provided at the uppermost storage layer, while three delivery openings 21b are provided at the lowermost storage layer. The stored goods R entered by the belt conveyer 25 through the entrance opening 21a are controlled to move multiple unit goods storage sections 21 at one stretch in depth direction with respect to the entrance opening 21a in the uppermost storage layer so as to move quickly, and are controlled to move unit by unit to neighboring unit goods storage section 21 at the front end and the rear end in the depth direction.

On the other hand, in the lowermost storage layer, the stored goods R are controlled to move unit by unit in front direction, rear direction, left direction and right direction for inside unit goods storage section 21, and to move unit by unit in three directions or two directions for remaining unit goods storage section 21 so as to move the stored goods R little by little in front direction, rear direction, left direction and right direction. Wherein, similar to the above, the stored goods R entered through the entrance opening 21a are moved downward from the uppermost storage layer to the lowermost storage layer, are moved through the unit goods storage section 21 by the goods conveyance means in each storage layer, are finally reached to any of three delivery openings 21b prior to delivery date and time, and are delivered by the belt conveyer 25 at the delivery date and time.

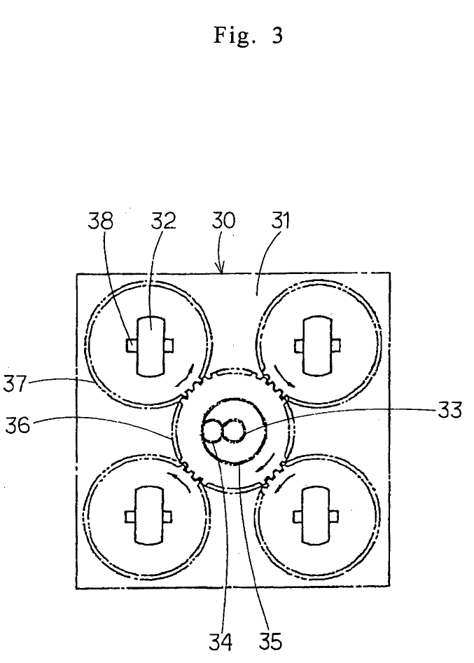

Next, actual examples of the goods conveyance means are described. FIG. 3 illustrates a schematic plan view of one of the actual example. The goods conveyance means 30 is disclosed in Japanese Patent Laid-Open Publication No. 2002-2932, entitled “Conveyance Direction Changing Apparatus”, the disclosure of which is incorporated herein by reference. When the goods conveyance means 30 is given an outline, the goods conveyance means 30 comprises a base table 31, a motor (not shown) disposed in the base table 31, multiple (four) rollers 32 projected from the surface of the base table 31, and supported in freely rotating manner and in freely changing direction manner, a first power transmission section for goods conveyance which takes rotating output following the forward/rearward rotation of the motor, and rotates the rollers 32, and a second power transmission section for changing direction which takes rotating output following the forward/reverse rotation of the motor, and changes the direction of each roller 32. Further, a sensor for detecting a stored good is provided at the base table 31.

In the second power transmission section for changing direction, a gear 33 is coupled to an annulus gear 35 through an idler 34. The annulus gear 35 is provided in one body with a second driving body 36. The second driving body 36 mates with second driven bodies 37 each supporting corresponding roller 32 rotationally. Consequently, when the second driving body 36 rotates in a direction illustrated with an arrow by the rotation of the motor, each of the second driven bodies 37 rotate in a direction illustrated with an arrow, with interlocking to the rotation of the second driving body 36, therefore the rotation direction of four rollers 32 change, the rotation direction being the same to one another.

On the other hand, in the first power transmission section, when a motor rotates, a first driving body rotates, a first driven body mating with the first driving body rotates, rollers 32 rotates by determining a horizontal axis 38 to be the central axis, each roller 32 being contacted its outer peripheral face against the first driven body.

When the motor forwardly rotates, the first driving body forwardly rotates, while the second driving body 36 does not rotate by a one-way clutch, then the rollers 32 rotate. On the contrary, when the motor reversely rotates, the second driving body 36 forwardly rotates, while the first driving body does not rotate by a one-way clutch, then the rollers 32 are changed their direction. The rotation and changing direction of the rollers 32 are controlled by the forward/reverse rotation of the motor, so that the stored good on the base table 31 is moved forward direction, rearward direction, left direction, and right direction.

The goods conveyance means 30 illustrated in FIG. 3 may be used solely. The goods conveyance means 30 may be used by connecting four goods conveyance means in rectangular shape, for example. Numbers and shape of the goods conveyance means 30 can properly be selected according to the size, weight and the like of the stored good for conveyance.

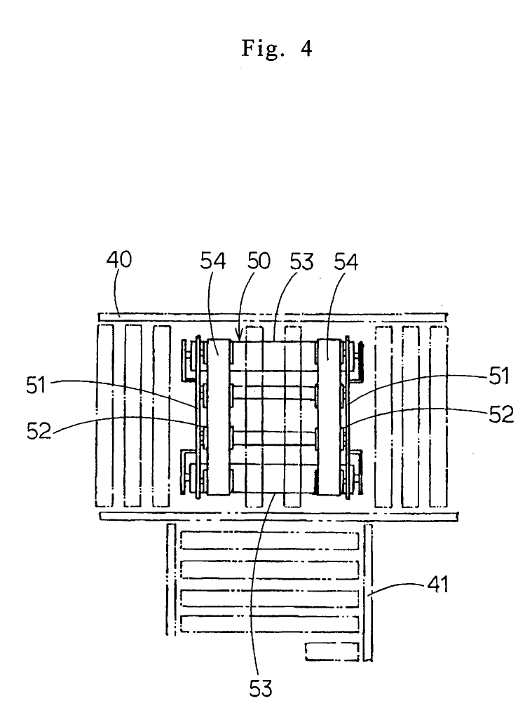

FIG. 4 illustrates a schematic plan view of the goods conveyance means of another actual example. The goods conveyance means is disclosed in Japanese Patent No. 3241487, entitled “Cross-Feeder”, the disclosure of which is incorporated herein by reference. The goods conveyance means comprises a conveyer-line 40 for conveying the stored goods in left/right direction on the drawing, and a cross-feeder 50 disposed on the conveyer-line 40. The cross-feeder 50 comprises a pair of support plates 51 disposed oppositely with a distance to one another, multiple pulleys 52 mounted to each support plate 51 rotationally in a horizontal row condition, two rollers 53 each housing a motor for conveyance, each roller 53 being erected rotationally between the pair of support plates 51, each roller 53 being below the pulleys 52 provided in a horizontal row condition, belts 54 each suspended from the rollers 53 and the pulleys 52 of each row, and an elevation section (not shown) for moving the entirety of the pair of the support plates 51 up/down.

In the goods conveyance means illustrated in FIG. 4, and when the stored goods are to be moved straightly on the conveyer-line 40, the entirety of the support plates 51 is moved down by the elevation section so as to lower the belts 54 than the rollers of the conveyer-line 40, then the stored goods are moved straightly as they are along the conveyer-line 40.

When the stored good is delivered from the conveyer-line 40 to another conveyer-line 41 which is disposed in a perpendicular direction with respect to the conveyer-line 40, a stopper (not shown) is projected so as to stop the stored good just above the cross-feeder 50, upon detection by the sensor (not shown) of the conveyance of the stored good onto the conveyer-line 40. Then, the entirety of the support plates 51 is moved up by the elevation section, the belts 54 are projected upper than the rollers of the conveyer-line 40, therefore the stored good is scooped up. Then, the rollers 53 housing the motor for conveyance are rotated, the belts 54 are driven interlocking to the rotation so that the stored good is moved from the conveyer-line 40 to the conveyer-line 41.

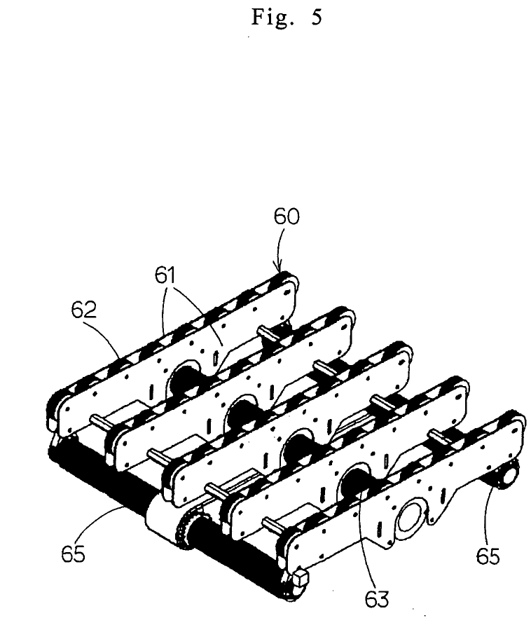

FIG. 5 illustrates a perspective view of goods conveyance means of a further actual example. The goods conveyance means is disclosed in Japanese Patent Laid-Open Publication No. 2000-168948, entitled “Cross-Feeder”, the disclosure of which is incorporated herein by reference. The goods conveyance means comprises a conveyer-line (not shown), and a cross-feeder 60 disposed to the conveyer-line. The cross-feeder 60 is used for moving the stored good from the conveyer-line to another conveyer-line disposed in perpendicular with respect to the conveyer-line, similarly to the goods conveyance means of FIG. 4.

The cross-feeder 60 comprises multiple sets (five sets) of a pair of support plates 61 disposed oppositely and in parallel to one another, multiple (eight) pulleys 62 mounted between the pair of the support plates 61 of each set in a rotational manner and in horizontal row manner, a roller 63 housing a motor for conveyance mounted between the pair of the support plates 61 of each set in a rotational manner, belts (not shown) each suspended from eight pulleys 62 between the pair of the support plates 61 of each set and from the roller 63, and an elevation section(consisting of two rollers 65 for housing a motor for moving up/down, and the like) for moving the entirety of the pair of the support plates 61 of each set up/down.

When the roller 65 consisting the elevation section rotates, the entirety of the pair of the support plates 61 of each set is moved up/down following to the rotation. Rollers of the conveyer-line are located in the gap between the support plates 61 of each set.

The cross-feeder 60 is moved down so as to locate the belts below the rollers of the conveyer-line, therefore the stored good is smoothly moved on the conveyer-line.

When the stored good is moved from the conveyer-line to another conveyer-line disposed in perpendicular to the former conveyer-line, a stopper (not shown) is projected so as to stop the stored good just above the cross-feeder 60, upon detection by the sensor (not shown) of the conveyance of the stored good onto the conveyer-line. Then, the entirety of the support plates 61 is moved up by the elevation section, the belts are projected upper than the rollers of the conveyer-line, therefore the stored good is scooped up. Then, the rollers 63 housing the motor for conveyance are rotated, the belts are driven interlocking to the rotation so that the stored good is moved from the conveyer-line to another conveyer-line.

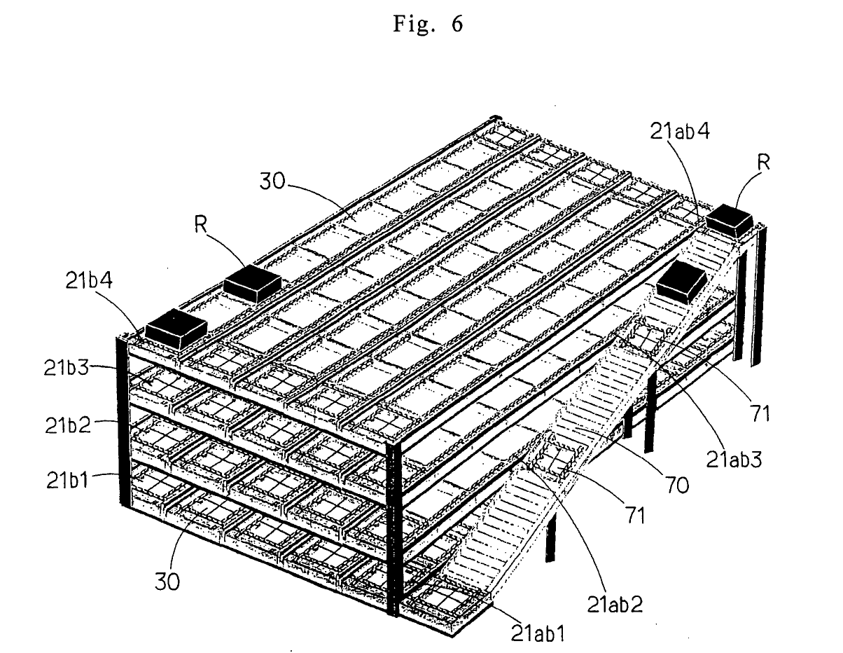

Then, an arrangement is described for entering/delivering stored goods with respect to each storage layer between the uppermost storage layer and the lowermost storage layer in a case that multiple storage layers are provided. FIG. 6 is a perspective view illustrating a goods storage section (storage space) in a three-dimensional warehouse, for the case.

In FIG. 6, four storage layers are provided. Each storage layer has 50 (=5^{×}10) unit goods storage sections. An entering/delivering opening 21a b4 is established for the uppermost storage layer, an entering/delivering opening 21ab3 is established for the next upper storage layer, an entering/delivering opening 21ab2 is established for further next storage layer, and an entering/delivering opening 21ab1 is established for the lowermost storage layer. Those entering/delivering openings 21ab1, 21ab2, 21ab3, and 21ab4 are established on the same side to one another, and an inclined conveyer 70 is disposed so as to oppose to those entering/delivering openings.

In this case, the goods conveyance means is arranged by the goods conveyance means 30 of each unit goods storage section, and the inclined conveyer 70. The inclined conveyer 70 comprises an entering/delivering opening 71 for entering/delivering stored goods with respect to each storage layer from the uppermost storage layer to the lowermost storage layer. The inclined conveyer 70 may be disposed in the exterior of the three-dimensional warehouse.

The stored good R in the uppermost storage layer is entered/delivered from the entering/delivering opening 21ab4 by the inclined conveyer 70, from the entering/delivering section 71 to each storage layer through the entering/delivering opening 21ab3, the entering/delivering opening 21ab2, the entering/delivering opening 21ab1 as the need arises, and is finally delivered from the entering/delivering opening 21ab1 of the lowermost storage layer.

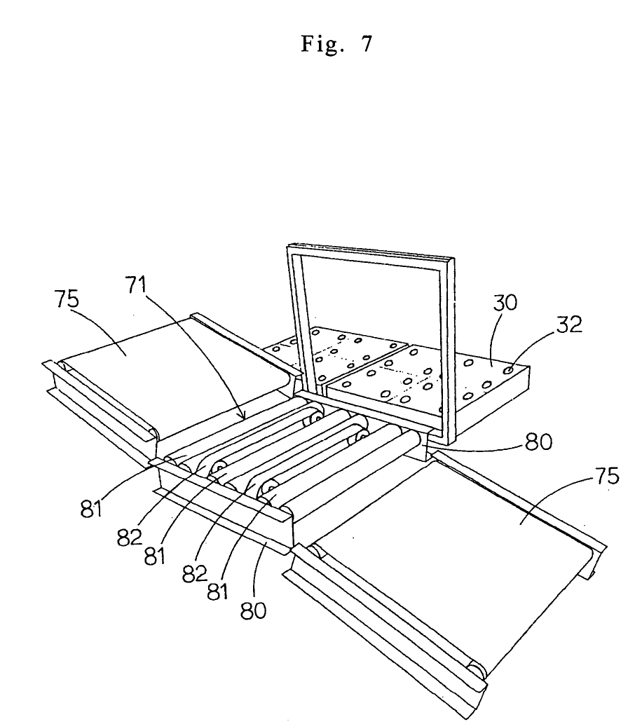

The entering/delivering section 71 of the inclined conveyer 70 may has an arrangement illustrated in FIG. 7. In the example of FIG. 7, the inclined conveyer 70 is arranged with a belt-conveyer 75 (which may be a motor-roller-conveyer). The entering/delivering section 71 has a pair of support plates 80 disposed in a facing to one another manner, rollers 81 housing a motor for conveyance, each roller 81 being supported between the support plates 80 in a rotational manner, and an elevation section for moving (consisted with a belt 82 and the like) mounted to the support plates 80 in a moving up/down manner. The rollers 81 are not limited their numbers, are determined their numbers suitable as well as the stored good can smoothly moved. The pair of support plates 80 is arranged such that the pair of support plates 80 is usually inclined by an angle which is the same as that of the belt-conveyer 75, and that the pair of support plates 80 becomes horizontal when the stored good is entered/delivered with respect to the storage layer.

In the entering/delivering section 71, and when the stored good conveyed from the upper storage layer by the belt-conveyer 75 is entered into the lower storage layer through the entering/delivering opening, the elevation section for conveyance is moved down so that the belts 82 are positioned below the rollers 81. The stored good conveyed by the belt-conveyer 75 is stopped temporarily by a stopper (not shown), is scooped by the belts 82 of the elevation section for conveyance which has then moved up, and is moved by the movement of the belts 82 onto the goods conveyance means 30 at the entering/delivering opening.

When the stored good is conveyed by the belt-conveyer 75 from the entering/delivering opening of the storage layer, the elevation section for conveyance is moved down so that the belts 82 are positioned below the rollers 81. The stored good at the entering/delivering opening is moved onto the entering/delivering section 71 by the goods conveyance means 30, is then moved down by the belt-conveyer 75 by the rotating of the rollers 81.

When the stored good conveyed by the belt-conveyer 75 is passed through the entering/delivering section 71 as it is, and is moved down, the elevation section for conveyance moves down so as to position the belts 82 below the rollers 81, and the stored good is smoothly passed through the entering/delivering section 71 and is moved down.

Although it is not illustrated in the drawing, an elevator may be employed instead the inclined conveyer 70. In this case, when description is made based upon the example of FIG. 6, entering/delivering can be carried out for each storage layer among the storage layers from the uppermost storage layer to the lowermost storage layer, by establishing the entering/delivering opening 21ab1, the entering/delivering opening 21ab2, the entering/delivering opening 21ab3, and the entering/delivering opening 21ab4 to be the same position except the vertical position and by providing the goods conveyance means 30 in the elevator. Further, in FIG. 6, each of the entering/delivering openings 21ab1, 21ab2, 21ab3, and 21ab4 may be provided to each storage layer, and those entering/delivering openings may be temporary entering/delivering openings.

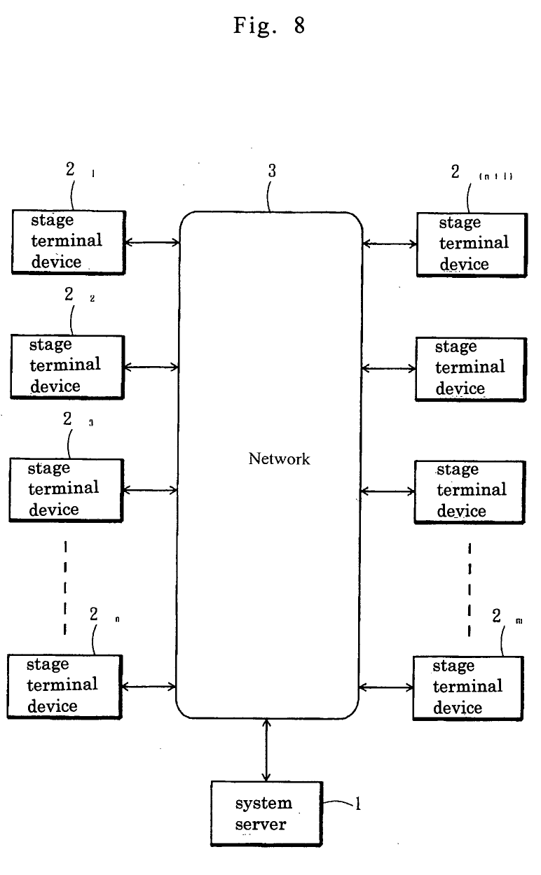

Next, control system for controlling the automatic storage and retrieval system of an embodiment according to the present invention is described. FIG. 8 is a block diagram illustrating an arrangement of the control system. The control system is consisted with a system server 1, stage terminal devices 2₋₁, . . . , 2₋ₘ, and a network 3 for connecting the system server 1 and the stage terminal devices 2₋₁, . . . , 2ₘ. The stage terminal device means the conveyance control means provided at the goods conveyance means 30, and the stage means the goods conveyance means 30.

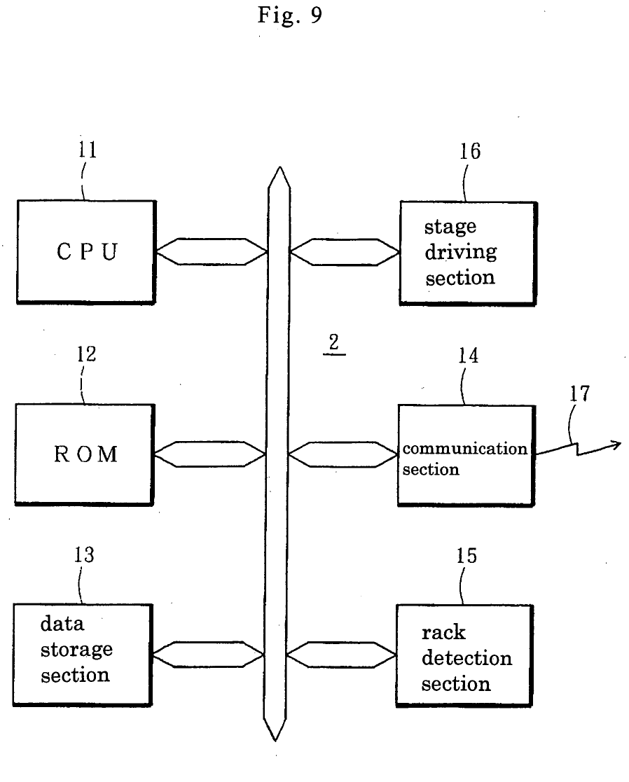

The system server 1 sends a command to each of the stage terminal devices 2₋₁, . . . , 2₋ₘ so that transferring of the data can be carried out. Each of the stage terminal devices 2₋₁, . . . , 2₋ₘ comprises a CPU 11, a ROM 12, a data storage section 13, a communication section 14, a rack (stored good) detector 15, and a stage driving section 16, as is illustrated in FIG. 9.

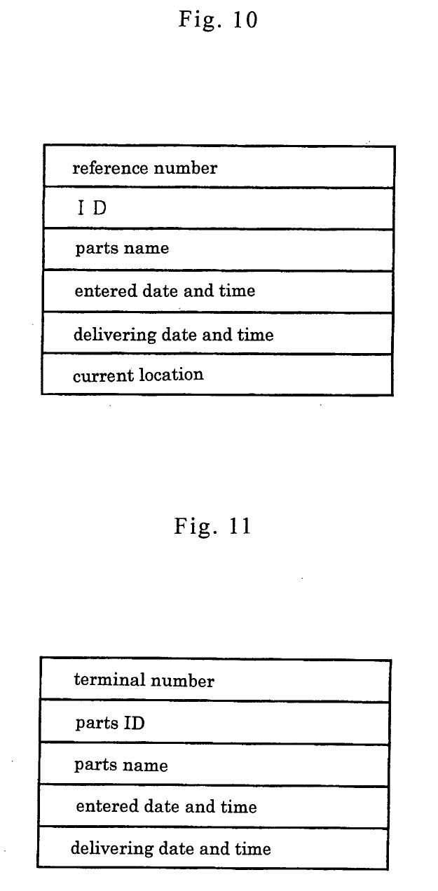

The CPU 11 carries out the communication with other terminal devices and the system server and the controlling of the stage driving. The ROM 12 stores programs which are carried out by the CPU 11. The data storage section 13 stores a parts ID, parts name, entered date and time, delivering date and time of a stored good which is currently on its stage, besides the self terminal number, as is illustrated in FIG. 11. Those data of the stored good are received from the stage terminal device at later location, and are stored, those data may be read from a card mounted on the stored good and are stored, by the rack detector 15. In the card of the stored good, a reference number of the card, ID, parts name, entered date and time, delivering date and time, and current location are stored, as is illustrated in FIG. 10.

The reference number, ID, parts name and entered date and time may be stored at the entering timing. Although, the delivering date and time may be entered when it is known at the entering timing, the delivery date and time may be instructed later by the system server. The current location is obtained by receiving information from the stage terminal device. The accuracy of the location can be improved by mutually checking which is carried out by comparing the data read by the rack detector 15 and the data from the stage terminal device.

The communication section 14 communicates with the neighboring stage terminal devices and the system server 1. The stage driving section 16 carries out driving ON/OFF of the motor in the goods conveyance means 30 for receiving and sending of the stored good, and controlling of the sending direction (direction of the rollers 32), according to the command from the CPU 11.

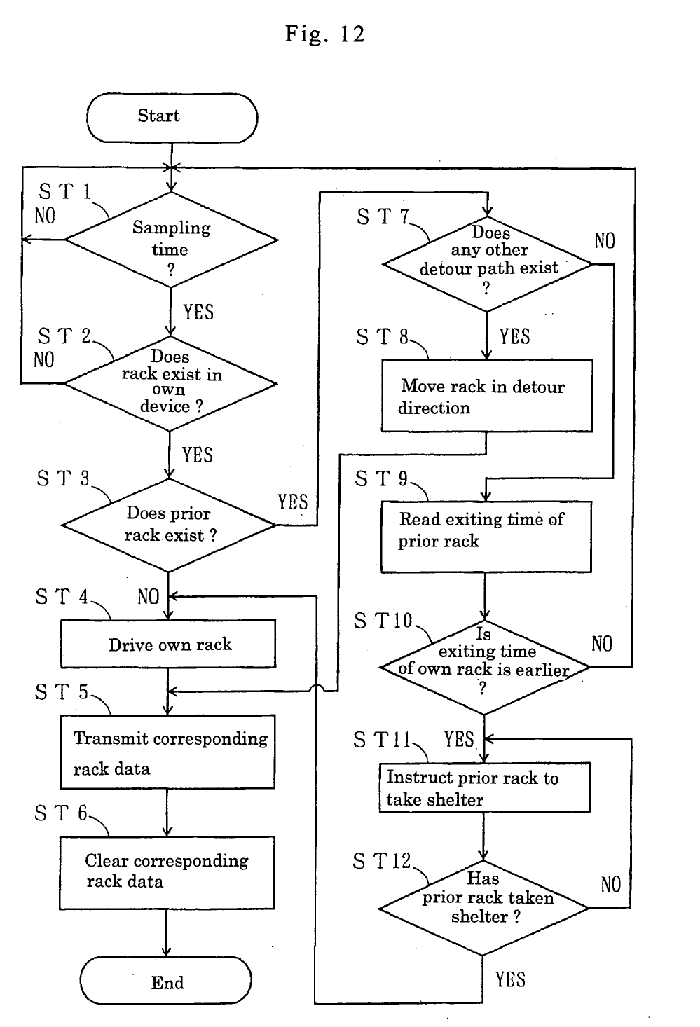

Then, referring to the flow diagram illustrated in FIG. 12, the processing operation of each of the stage terminal devices 2₋₁, . . . , 2₋ₘ is described. In step ST1, when the sampling time has reached, then the processing shifts to step ST2. The sampling time is generated periodically or based upon predetermined condition in the stage terminal device itself, but the sampling time may be transmitted from the system server 1. In this case, the system server 1 determines delivery frequency for every stored good, and instructs the delivery frequency, so that the system server 1 manages the sampling time based upon those information (delivery frequency).

In step ST2, it is judged whether or not a rack (stored good) is on the stage of the own device. When it is judged that a rack is on the stage of the own device based upon the storage contents of the data storage section 13 or the read data by the rack detector 15, the processing shifts to step ST3. When it is judged that a rack is not on the stage of the own device, the processing returns step ST1. Then, the processing waits for the arrival of the next sampling time.

In step ST3, it is judged whether or not a rack is on the stage which is one stage prior to the current stage in advancing direction. This judgment can be carried out by the inquiry communication to the fore stage terminal device. When it is judged in step ST3 that a rack is on the prior stage, the processing shifts to step ST7. On the other hand, when it is judged in step ST3 that a rack is not on the prior stage, the processing shifts to step ST4.

In step ST4, although a rack is not on the prior stage, the stage driving is turned ON for sending the own rack to the prior stage. Then, the processing shifts to step ST5. In step ST5, data for the sent rack is transmitted to the prior stage terminal device. Then, the processing shifts to step ST6. In step ST6, data for the just sent rack stored in the data storage section 13 is cleared. Then the processing is finished.

In step ST7, it is judged whether or not detour exist which reaches a fore position up to the delivering. When it is judged that detour exist, the processing shifts to step ST8. On the other hand, when it is judged that detour do not exist, the processing shifts to step ST9. In step ST8, the stage driving is turned ON with its direction changed so as to send out the own rack to the detour. Then, the processing shifts to step ST5, similarly to the movement in the fore-direction, the data of the just sent rack is transmitted to the stage terminal device to which the rack is sent. Then, the processing shifts to step ST6, rack data in the data storage section 13 is cleared. Then, the processing is finished.

In step ST9, the fore rack is required to take shelter, and the fore stage terminal device is required to transmit the delivering date and time of the fore rack for judging whether or not the front location can be emptied, and the delivering date and time of the fore rack is read. Then, the processing shifts to step ST10. In step ST10, the read delivering date and time of the fore rack is compared with the delivering date and time of the own rack. When the delivering date and time of the own rack is earlier, the processing shifts to step ST11. On the other hand, when the delivering date and time is not earlier or is the same to that of the fore rack, the processing returns step ST1. In step ST1, the next sampling time is waited to arrive.

In step ST11, request for taking shelter of the rack is transmitted to the fore stage terminal device. Then, the processing shifts to step ST12. In step ST12, it is judged whether or not the fore rack has taken shelter. When the fore rack has taken shelter, the processing shifts to step ST4. On the other hand, when the fore rack has not taken shelter, the processing returns step ST11. In step ST11, request for taking shelter is transmitted to the fore stage terminal device again. When the rack is taken shelter, the fore stage becomes empty. So, in step ST4, the own rack is driven forward and is sent out. After the sending out, in steps ST5 and ST6, the rack data is transmitted, the rack data is cleared, the processing is then finished, similarly to the foregoing processing.

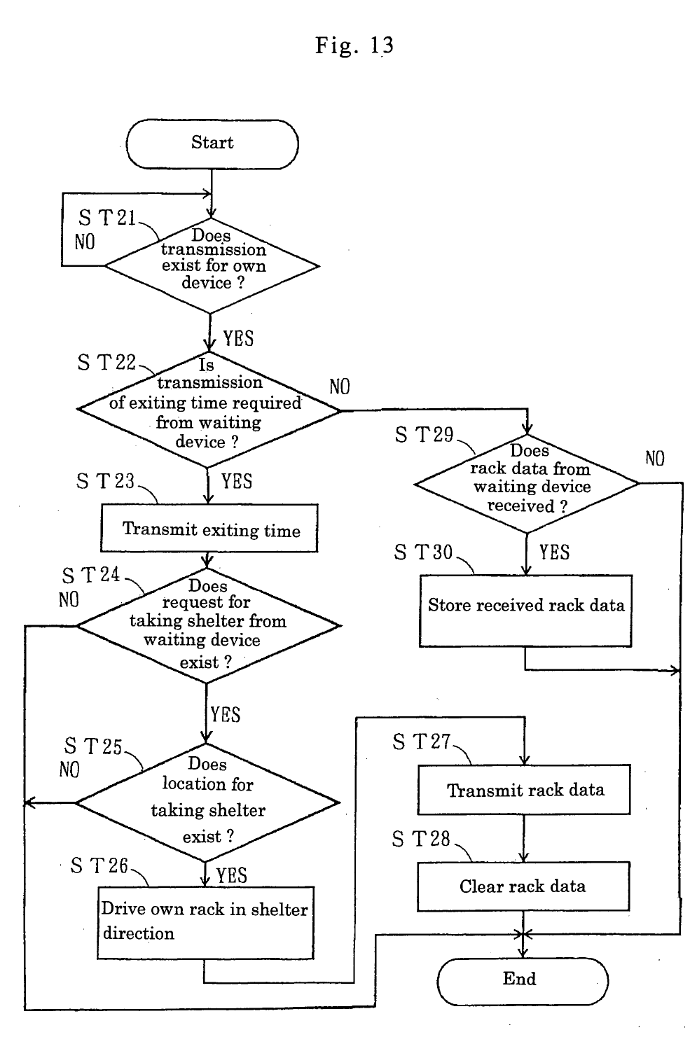

Next, the reception interruption processing is described by referring to the flow diagram illustrated in FIG. 13, the reception interruption processing being carried out upon transmission request and the like of data from the rear terminal device to the own device, in the stage terminal devices 2₋₁, . . . , 2₋ₘ. In step ST21, it is judged that transmission exists to the own device, that is the reception interruption exists, the processing shifts to step ST22. In step ST22, it is judged whether or not the transmission is the transmission request for transmitting the delivering date and time from the rear stage terminal device. When the transmission is the transmission request for transmitting the delivering date and time, the processing shifts to step ST23. On the other hand, when the transmission is not the transmission request for transmitting the delivering date and time, the processing shifts to step ST29.

In step ST23, the delivering date and time of the rack of the own device is transmitted to the rear stage terminal device. Then, the processing shifts to step ST24. In step ST24, it is judged whether or not request for taking shelter is given from the rear stage terminal device. When the delivering date and time of the rack of the rear stage is earlier, and when the request for taking shelter is given from the rear device, the processing shifts to step ST25. On the other hand, the request for taking shelter is not given for a constant time period, the processing returns. In step ST25, it is judged whether or not location for taking shelter exists. When the location for taking shelter exists in the left side, right side or the like, the processing shifts to step ST26. On the other hand, when the location for taking shelter does not exist, the processing returns. In this case, it is better to notice the fact to the rear device.

In this case, the fact may be notified to the system server 1 side, taking shelter, detour may be managed as system on system server 1 side, and the taking shelter, detour may be instructed to the stage terminal device. A certain stage only for taking shelter may be provided in the storage layer so that taking shelter will be always possible. For example, 10-20% of the storage layer may be assigned to be stages only for taking shelter. The stages only for taking shelter may be properly determined because too large stages only for taking shelter results decreasing in storage amount of goods.

In step ST26, the rack on the own stage is driven towards the shelter direction. Then, the processing shifts to step ST27. In step ST27, the rack data stored in the data storage section 13 is transmitted to the stage terminal device of the shelter location. Then, the processing shifts to step ST28. In step ST28, the rack data stored in the data storage section 13 is cleared. Then, the processing is finished.

In step ST29, it is judged whether or not the rack data from the rear device is received. When the rack data from the rear device is received, the processing shifts to step ST30. On the other hand, when the rack data from the rear device is not received, the processing shifts to the processing according to the reception contents or the processing returns. In step ST30, the received rack data is stored in the data storage section 13, then the processing returns.

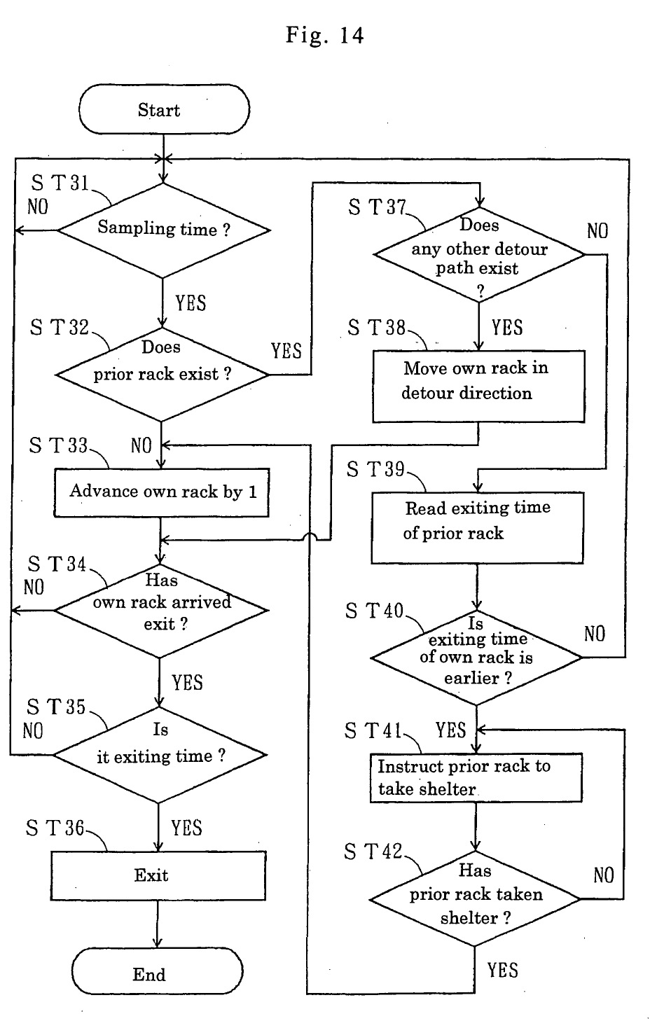

In the flow diagram of the above embodiment, the moving control of the rack on each stage is carried out by the stage terminal device provided on each stage, but those terminal devices may be provided on moving rack. The processing operation of the rack terminal device is described by referring to the flow diagram illustrated in FIG. 14.

In step ST31, when the sampling time has reached, then the processing shifts to step ST32. In step ST32, it is judged whether or not a rack exists on a stage which is prior by one stage with respect to the present stage in the advancing direction. The judgment is carried out by performing inquiry communication to the rack terminal device in the forward direction. When it is judged in step ST32 that a rack exists on the stage, then the processing shifts to step ST37. On the contrary, when it is judged that no rack exist on the stage, the processing shifts to step ST33.

In step ST33, the stage driving is turned ON so as to send the own rack to the forward stage, because no rack exist in the forward stage. The current position within the rack data of the rack terminal device is advanced by 1, at this time. Then, the processing shifts to step ST34. In step ST34, it is judged whether or not the rack has reached the delivering opening. When it is judged in step ST34 that the rack has not reached the delivering opening, the processing returns to step ST31. In step ST31, the reaching of the next sampling time is waited.

On the contrary, when it is judged in step ST34 that the rack has reached to delivering opening, the processing then shifts to step ST35. In step ST35, it is judged whether or not it is the delivering date and time. When it is judged in step ST35 that the delivering date and time have not reached yet, the processing returns to step ST 31. In step ST31, the reaching of the next sampling time is waited. On the contrary, when it is judged in step ST35 that the delivering date and time have reached, the processing shifts to step ST 36. In step ST36, the rack is delivered from the delivering opening. The delivering of the rack from the delivering opening may be carried out based upon the command from the system server.

In step ST37, it is judged whether or not a detour path exists reaching a forward stage getting to the delivering. When it is judged in step ST37 that a detour path exists, the processing shifts to step ST38. On the contrary, when it is judged in step ST37 that no detour path exist, the processing shifts to step ST39. In step ST38, the stage driving is changed its direction and is turned ON in order to sending the own rack to the detour path. Then, the processing shifts to step ST34. In step ST34, it is judged whether or not the rack has reached the delivering opening, similarly to the case where a rack is moved in the forward direction. When it is judged in step ST34 that the rack has not reached the delivering opening, the processing returns to step ST31. In step ST31, the reaching of the next sampling time is waited.

In step ST39, taking shelter for the prior rack, transmission of the delivering date and time of the prior rack is required, and the delivering date and time of the prior rack is read, for judging whether or not the prior rack can made the prior stage to be empty. Next, the processing shifts to step ST40. In step ST40, the delivering date and time of the prior rack thus read is compared with the delivering date and time of the own rack. When it is judged in step ST40 that the delivering date and time of the own rack is earlier, the processing shifts to step ST41. On the contrary, when it is judged in step ST40 that the delivering date and time of the own rack is not earlier, the processing shifts to step ST31. In step ST31, the reaching of the next sampling time is waited.

In step ST41, the request for taking shelter for the prior rack is transmitted to the prior rack terminal device. Next, the processing shifts to step ST42. In step ST42, it is judged whether or not the prior rack has taken shelter. When it is judged in step ST42 that the prior rack has taken shelter, the processing shifts to step ST33. On the contrary, when it is judged in step ST42 that the prior rack has not taken shelter, the processing returns to step ST41. In step ST41, the request for taking shelter for the prior rack is transmitted again to the prior rack terminal device. When the prior rack has taken shelter, the prior stage becomes empty. Therefore, in step ST33, the own rack is driven in forward direction and is sent out.

In this way, when this automatic storage and retrieval system is employed, the housing space within the warehouse is effectively utilized up to its maximum, while the operation from entering of goods to delivering of the goods is carried out unmanned condition with efficiency. This automatic storage and retrieval system is portable which can easily be located, and moved to anywhere, and can easily be changed its arrangement. When the goods conveyance means 30 illustrated in FIG. 3 is especially employed as a goods conveyance means provided at a unit goods storage section in each storage layer within the warehouse, the stored goods can easily be moved in any one of front, rear, left, and right directions by putting the goods conveyance means 30 all over. Moreover, within the goods conveyance means 30, the rollers only rotate or change its direction, the power consumption for the operation is low, and dangerous movement mechanism consuming great energy is not provided, therefore the goods conveyance means is safe and is energy saving.

In the above embodiments, the delivering date and time is stored in a card of each of stored goods. But, the delivering date and time may not be fixed when the goods are entered. It may be possible as other embodiments that frequency in use of the stored goods is stored in a card, for example, frequency such as delivering is carried out everyday, once per week, once for 10 days, or the like according to the stored goods is stored, the stored goods with high frequency are moved in the vicinity of the delivering opening, the delivering date and time is instructed from the main server, the stored goods are delivered upon arrival to the instructed time, or are shifted to delivering immediately upon the delivering instruction. It may also be possible that the stored goods may wait at a predetermined position within the warehouse according to the delivering frequency.

When this automatic storage and retrieval system is employed, it bears the intermediate warehouse function which is required for the distribution and production control system corresponding to the supply chain management. Specifically, the distribution center of s-commerce, freezer, library, hospital (medicine distribution center), bank, public office (documents), control of parts in stock and stage of work in manufacturing factory, warehouse for retail trade, refrigerator for foods and the like are exemplified as the usage of this automatic storage and retrieval system.

As is described above, the automatic storage and retrieval system and the method for conveying stored goods within the three-dimensional warehouse have following effects.

The housing space within the warehouse is effectively utilized up to its maximum, while the operation from entering of goods to delivering of the goods is carried out unmanned condition with efficiency.

The stored goods are securely delivered at the delivery date and time which is set for each of the stored goods.

The automatic storage and retrieval system can easily be located, and moved to anywhere, and can easily be changed its arrangement.

When the goods conveyance means of the second aspect of the present invention is especially employed, the stored goods can easily be moved in any one of front, rear, left, and right directions.

Dangerous movement mechanism consuming great energy is not provided, therefore the goods conveyance means is safe and is energy saving.

The automatic storage and retrieval system bears the intermediate warehouse function which is required for the distribution and production control system corresponding to the SCM (supply chain management).

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

1. An automatic storage and retrieval system comprising:
at least one entrance opening for entering goods into a three-dimensional warehouse;
at least one delivery opening for delivering goods from the three-dimensional warehouse;
a plurality of goods storage sections each having at least one layer of storage layer on which a plurality of unit goods storage sections are disposed in matrix;
a goods conveyance structure provided in each of the unit goods storage sections, the goods conveyance structure being configured to receive/deliver stored goods by selecting the stored goods in a flexible direction; and
a conveyance control device configured to direct the stored good to the delivery opening by delivery date and time of the stored good, upon entrance of the stored good through the entrance opening.

2. The automatic storage and retrieval system as set forth in claim 1, wherein
the goods conveyance structure comprises a conveyance direction change section for changing the conveyance direction to any one direction among forward, reverse, left and right directions, and a goods conveyance section for conveying the stored good in the direction changed by the conveyance direction change section.

3. The automatic storage and retrieval system as set forth in claim 1, wherein
the goods conveyance structure comprises a conveyer line for conveying the stored good in one direction, and a cross-feeder disposed within the conveyer line, the cross-feeder delivering the stored good into another conveyer line for conveying in a direction perpendicular to the conveyance direction of the conveyer line from which the stored good is delivered.

4. The automatic storage and retrieval system as set forth in claim 1, wherein
the goods conveyance structure comprises an inclined conveyer for conveying the stored good from the upper storage layer to the lower storage layer in a case that the goods storage section has multiple storage layers, and wherein the inclination layer has an entrance/delivery section for entering into/delivering from with respect to each storage layer which is one storage layer from the uppermost storage layer to the lowermost storage layer.

5. The automatic storage and retrieval system as set forth in claim 1, wherein
the goods conveyance structure comprises an elevator for conveying the stored good from an upper storage layer to a lower storage layer, and vice versa in a case that the goods storage section has multiple storage layers.

6. The automatic storage and retrieval system as set forth in claim 1, wherein
the conveyance control device is configured to control conveyance of the stored good to a neighboring unit goods storage section in a case that the neighboring unit goods storage section in the conveyance direction of the stored good has no stored goods.

7. The automatic storage and retrieval system as set forth in claim 4, wherein
the conveyance control device is configured to control conveyance of the stored good to a neighboring unit goods storage section in a case that the neighboring unit goods storage section in the conveyance direction of the stored good has no stored goods.

8. The automatic storage and retrieval system as set forth in claim 5, wherein
the conveyance control device is configured to control conveyance of the stored good to a neighboring unit goods storage section in a case that the neighboring unit goods storage section in the conveyance direction of the stored good has no stored goods.

9. The automatic storage and retrieval system as set forth in claim 1, wherein
the conveyance control device is configured to search for a detour in a case that the neighboring unit goods storage section in the conveyance direction of the stored good has stored goods, and wherein the conveyance control device is configured to control conveyance of the stored good in the detour direction in a case that the detour exists.

10. The automatic storage and retrieval system as set forth in claim 4, wherein
the conveyance control device is configured to search for a detour in a case that the neighboring unit goods storage section in the conveyance direction of the stored good has stored goods, and wherein the conveyance control device is configured to control conveyance of the stored good in the detour direction in a case that the detour exists.

11. The automatic storage and retrieval system as set forth in claim 5, wherein
the conveyance control device is configured to search for a detour in a case that the neighboring unit goods storage section in the conveyance direction of the stored good has stored goods, and wherein the conveyance control device is configured to control conveyance of convey the stored good in the detour direction in a case that the detour exists.

12. The automatic storage and retrieval system as set forth in claim 1, wherein
the conveyance control device is configured to search for a detour in a case that the neighboring unit goods storage section in the conveyance direction of the stored good has stored goods, and wherein the conveyance control device is configured to compare the delivery date and time of the stored good for conveyance and the delivery date and time of the stored good in the neighboring unit goods storage section, and wherein the conveyance control device is configured to make the stored good in the neighboring unit goods storage section to take shelter in a case that the delivery date and time of the stored good for conveyance is earlier.

13. The automatic storage and retrieval system as set forth in claim 4, wherein
the conveyance control section device is configured to search for a detour in a case that the neighboring unit goods storage section in the conveyance direction of the stored good has stored goods, and wherein the conveyance control device is configured to compare the delivery date and time of the stored good for conveyance and the delivery date and time of the stored good in the neighboring unit goods storage section, and wherein the conveyance control device is configured to make the stored good in the neighboring unit goods storage section to take shelter in a case that the delivery date and time of the stored good for conveyance is earlier.

14. The automatic storage and retrieval system as set forth in claim 5 wherein
the conveyance control device is configured to search for a detour in a case that the neighboring unit goods storage section in the conveyance direction of the stored good has stored goods, and wherein the conveyance control device is configured to compare the delivery date and time of the stored good for conveyance and the delivery date and time of the stored good in the neighboring unit goods storage section, and wherein the conveyance control device is configured to make the stored good in the neighboring unit goods storage section to take shelter in a case that the delivery date and time of the stored good for conveyance is earlier.

15. The automatic storage and retrieval system as set forth in claim 1, wherein
the conveyance control device is provided at the goods conveyance structure of each of the unit goods storage sections.

16. The automatic storage and retrieval system as set forth in claim 4, wherein
the conveyance control device is provided at the goods conveyance structure of each of the unit goods storage sections.

17. The automatic storage and retrieval system as set forth in claim 5, wherein
the conveyance control device is provided at the goods conveyance structure of each of the unit goods storage sections.

18. The automatic storage and retrieval system as set forth in claim 6, wherein
the conveyance control device is provided at the goods conveyance structure of each of the unit goods storage sections.

19. The automatic storage and retrieval system as set forth in claim 9, wherein
the conveyance control device is provided at the goods conveyance structure of each of the unit goods storage sections.

20. The automatic storage and retrieval system as set forth in claim 12, wherein
the conveyance control device is provided at the goods conveyance structure of each of the unit goods storage sections.

21. The automatic storage and retrieval system as set forth in claim 1, wherein
the conveyance control device is provided at each stored good.

22. The automatic storage and retrieval system as set forth in claim 4, wherein
the conveyance control device is provided at each stored good.

23. The automatic storage and retrieval system as set forth in claim 5, wherein
the conveyance control device is provided at each stored good.

24. The automatic storage and retrieval system as set forth in claim 6, wherein
the conveyance control device is provided at each stored good.

25. The automatic storage and retrieval system as set forth in claim 9, wherein
the conveyance control device is provided at each stored good.

26. The automatic storage and retrieval system as set forth in claim 12, wherein
the conveyance control device is provided at each stored good.

27. The automatic storage and retrieval system as set forth in claim 1, further comprising
a system server for carrying out supervising control of the conveyance control device.

28. The automatic storage and retrieval system as set forth in claim 4, further comprising
a system server for carrying out supervising control of the conveyance control device.

29. The automatic storage and retrieval system as set forth in claim 5, further comprising
a system server for carrying out supervising control of the conveyance control device.

30. The automatic storage and retrieval system as set forth in claim 6, further comprising
a system server for carrying out supervising control of the conveyance control device.

31. The automatic storage and retrieval system as set forth in claim 9, further comprising
a system server for carrying out supervising control of the conveyance control device.

32. The automatic storage and retrieval system as set forth in claim 12, further comprising
a system server for carrying out supervising control of the conveyance control device.

33. The automatic storage and retrieval system as set forth in claim 15, further comprising
a system server for carrying out supervising control of the conveyance control device.

34. The automatic storage and retrieval system as set forth in claim 21, further comprising
a system server for carrying out supervising control of the conveyance control device.

35. A method for conveying stored goods within a three-dimensional warehouse which comprises at least one entrance opening for entering goods into the three-dimensional warehouse, at least one delivery opening for delivering goods from the three-dimensional warehouse, and a goods storage section having at least one layer of storage layer on which unit goods storage sections are disposed in matrix, the method comprising the steps of:
sequentially entering stored goods through an entrance opening of the three-dimensional warehouse which has a goods conveyance structure configured to direct goods with respect to each of the unit goods storage sections by selecting the stored goods in a flexible direction; and
conveying the stored goods through the unit goods storage section by the goods conveyance structure of each of the unit goods storage sections; and guiding the stored good to the delivery opening by the delivery date and time of the stored good.
